(19) United States
(12) Patent Application Publication
(10) Pub. No.: US 2019/0084314 A1
(43) Pub. Date: Mar. 21, 2019

(54) DEAERATOR AND INKJET RECORDING DEVICE

(71) Applicant: Konica Minolta Inc., Chiyoda-ku Tokyo (JP)

(72) Inventors: Masahiro YAMAGUCHI, Toyokawa-shi Aichi (JP); Tomoyoshi YUKIMOTO, Nagoya-shi Aichi (JP); Seiji SHIBATA, Toyokawa-shi Aichi (JP)

(21) Appl. No.: 16/136,927

(22) Filed: Sep. 20, 2018

(30) Foreign Application Priority Data
Sep. 21, 2017 (JP) 2017-181267

(51) Int. Cl. B41J 2/19; B41J 2/175; C09D 11/30

(52) U.S. Cl. CPC B41J 2/19; C09D 11/30; B41J 2/17563; B41J 2/17596

(57) ABSTRACT

A deaerator includes: a deaeration module that removes a gas contained in liquid; and a heating device that is provided integrally with the deaeration module and heats the deaeration module, wherein the deaeration module and the heating device are provided in a manner detachable from each other.

### CROSS-REFERENCE TO RELATED APPLICATION

The present application claims priority under 35 U.S.C. § 119 to Japanese Patent Application No. 2017-181267, filed on Sep. 21, 2017, the entire contents of which are incorporated herein by reference.

### BACKGROUND

### Technological Field

The present invention relates to a deaerator and an inkjet recording device.

### Description of the Related art

An inkjet recording device including a deaerator is known. For example, a UV curable inkjet recording device disclosed in JP 2014-208421 A includes: an ink channel that supplies an ink composition to a head; a heating device provided on an ink channel and adapted to heat an ion composition; and a deaerator provided on the ink channel on a downstream side of the heating device and adapted to deaerate the ink composition.

Additionally, an inkjet recording device disclosed in WO 2015/190200 A1 includes: a deaeration module provided on an ink channel and including a hollow fiber film; a first heating unit provided inside the deaeration module and including a heating wire and a thermocouple inside a bar-like member; and a second heating unit provided in a manner covering an outer peripheral surface of the deaeration module and including a rubber heater and the like.

Furthermore, the inkjet recording device disclosed in JP 2014-69401 A includes a deaeration module in order to remove a dissolved gas contained in ink supplied to a recording head.

In an inkjet recording device, various kinds of control are performed for ink in order to keep the ink in a high quality state, and one of such control is “ink deaeration (defoaming)”. By deaerating the ink, the ink can be smoothly and normally jetted from an inkjet head nozzle, and it is possible to suppress occurrence of image defect, so-called “nozzle clogging”.

On the other hand, as an ink deaeration method, there is a method of performing vacuum deaeration by using a deaeration module including a gas permeable film such as a hollow fiber filter, but since the gas permeable film is gradually worn out, the deaeration module is needed to be periodically replaced. At the time of replacing the deaeration module, excellent workability is required. Particularly, in an inkjet recording device for industrial use in which performance such as high image quality and high speed are required, a deaeration module is large in weight and it is highly demanded to shorten a downtime (non-printing time) of the device. Therefore, excellent workability at the time of replacing the deaeration module is further required.

### SUMMARY

Considering above, an object of the present invention is to solve the above-described problems and also to provide: a deaerator having excellent workability at the time of replacing a deaeration module; and an inkjet recording device including such a deaerator.

To achieve at least one of the abovementioned objects, according to an aspect of the present invention, a deaerator reflecting one aspect of the present invention comprises: a deaeration module that removes a gas contained in liquid; and a heating device that is provided integrally with the deaeration module and heats the deaeration module, wherein the deaeration module and the heating device are provided in a manner detachable from each other.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a cross-sectional view illustrating an inkjet recording device according to a first embodiment of the present invention;

FIG. 2 is a perspective view illustrating a carriage in FIG. 1;

FIG. 3 is a block diagram illustrating a configuration in the periphery of the carriage in FIG. 2;

FIG. 4 is a diagram illustrating an ink flow in the periphery of the carriage in FIG. 2;

FIG. 5 is a view illustrating a principle of liquid deaeration;

FIG. 6 is a cross-sectional view illustrating a gas permeable film;

FIG. 7 is a perspective view illustrating a deaerator;

FIG. 8 is a perspective view illustrating a deaeration module in FIG. 7;

FIG. 9 is a cross-sectional view illustrating the deaeration module in FIG. 7;

FIG. 10 is an exploded view of a heating device in FIG. 7;

FIG. 11 is a perspective transparent view illustrating a range surrounded by a two-dot chain line XI in FIG. 7;

FIG. 12 is a cross-sectional view illustrating the heating device viewed from an arrow direction on a line XII-XII in FIG. 7;

FIG. 13 is an enlarged perspective view illustrating a range surrounded by a two-dot chain line XIII in FIG. 7;

FIG. 14 is a flowchart illustrating a control flow of the deaerator;

FIG. 15 is a block diagram of a configuration related to the control flow in FIG. 14;

FIG. 16 is a cross-sectional view illustrating a state in which the heating device is separated from the deaeration module by separating operation of a separation system;

FIG. 17 is a cross-sectional view illustrating a modified example in a state in which the heating device in FIG. 16 is separated from the deaeration module;

FIG. 18 is a perspective view illustrating a first modified example of the carriage in FIG. 2;

FIG. 19 is an enlarged perspective view illustrating a range surrounded by a two-dot chain line XIX in FIG. 18;

FIG. 20 is an enlarged perspective view illustrating a range surrounded by a two-dot chain line XX in FIG. 18;

FIG. 21 is a cross-sectional view illustrating a first modified example of the deaerator in FIG. 3;

FIG. 22 is a cross-sectional view illustrating a second modified example of the deaerator in FIG. 3;

FIG. 23 is a perspective view illustrating a second modified example of the carriage in FIG. 2; and

FIG. 24 is a perspective view illustrating a UV irradiation device in FIG. 23.

### DETAILED DESCRIPTION OF EMBODIMENTS

Hereinafter, one or more embodiments of the present invention will be described with reference to the drawings. However, the scope of the invention is not limited to the disclosed embodiments. Note that, in the drawings referred to below, an identical member or an equivalent member is denoted by the same reference sign.

### First Embodiment

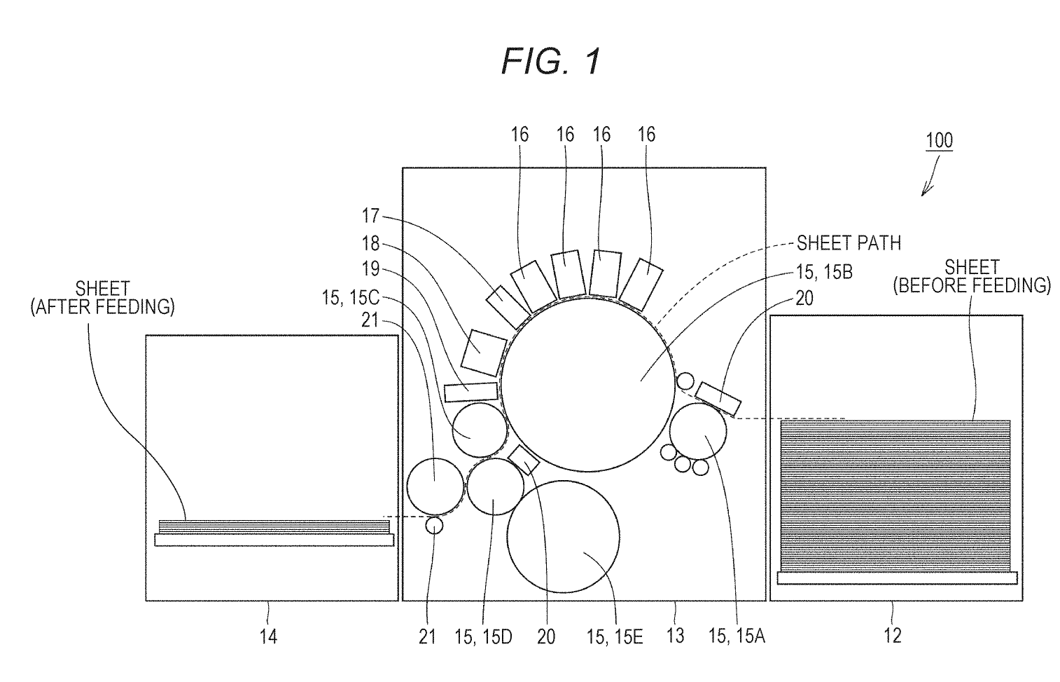

FIG. 1 is a cross-sectional view illustrating an inkjet recording device according to a first embodiment of the present invention. First, an entire structure of an inkjet recording device 100 will be described with reference to FIG. 1. The inkjet recording device 100 according to the present embodiment includes a feeder 12, a main body 13, and a delivery unit 14.

The feeder 12 stores sheets for recording. A sheet feeder (not illustrated) to feed a sheet toward the main body 13 is provided above the sheets loaded on the feeder 12.

The main body 13 includes a plurality of kinds of cylinders 15 in order to convey a sheet. In the present embodiment, provided as the plurality of kinds of cylinders 15 are: an A type cylinder 15A; a triple size cylinder 15B; a T1 cylinder 15C; a T2 cylinder 15D; and a double size cylinder 15E. These cylinders 15 each convey a sheet by holding the sheet.

The main body 13 further includes a plurality of carriages 16. As described later, each of the carriages 16 is provided with an inkjet head module, a deaerator, and an ink channel member. The plurality of carriages 16 is provided in a manner corresponding to four colors of cyan (C), magenta (M), yellow (Y), and black (K). Ink is supplied to each of the carriages 16 from an ink supply tank (not illustrated). The ink supplied to each of the carriages 16 is heated inside the ink channel, air bubbles contained in the ink are removed by the deaerator, and pressure is controlled to jet or hold the ink.

The main body 13 further includes a mist catcher 17, an ultraviolet (UV) irradiation device 18, an inline sensor 19, and a plurality of heaters 20. The mist catcher 17 collects mist generated by ink jetting from an inkjet head in order to prevent image defect and peripheral contamination. The UV irradiation device 18 irradiates a sheet with UV light in order to cure an ink image formed on the sheet. The inline sensor 19 reads image information formed on the sheet in order to perform image correction of color density, image inclination, and the like.

The main body 13 further includes a conveyance roller 21. The conveyance roller 21 conveys a sheet from the main body 13 toward the delivery unit 14. The sheet fed from the main body 13 is loaded on the delivery unit 14.

The inkjet recording device 100 is used by being directly connected to a computer or connected to the computer via a network. Image data to be printed on a sheet is transferred from the computer to a control device (controller) inside the inkjet recording device 100. The ink is jetted toward a sheet from an inkjet head inside each carriage 16 on the basis of the image data transferred to the control device. The ink placed on the sheet is cured by UV irradiation from the UV irradiation device 18, and then image formation is completed.

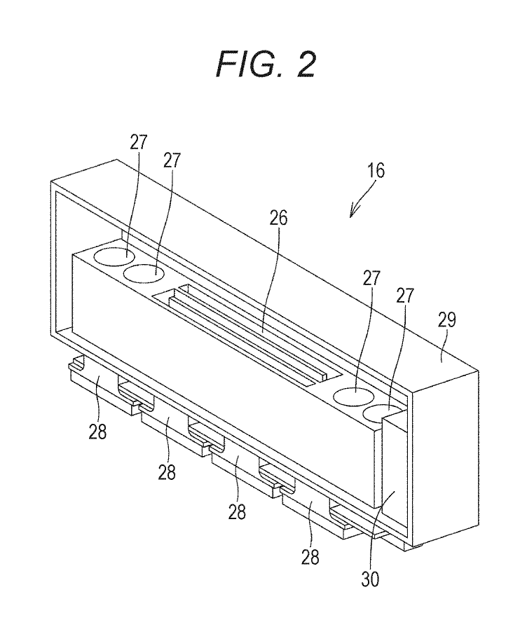

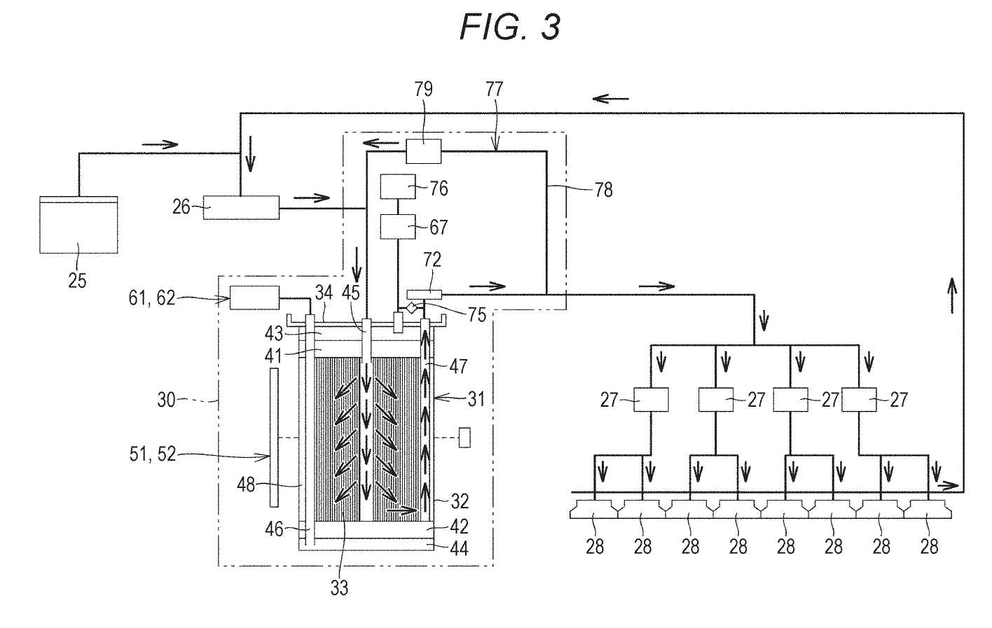

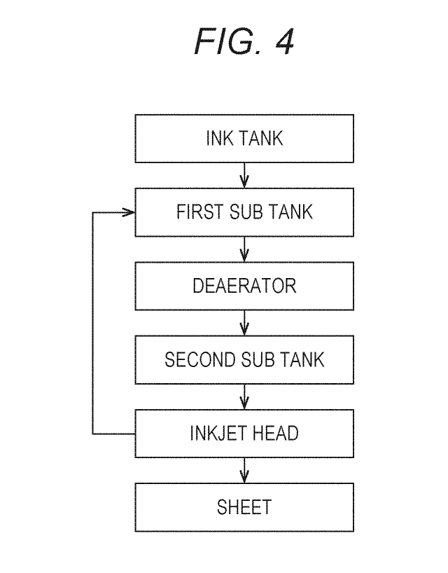

FIG. 2 is a perspective view illustrating one of the carriages in FIG. 1. FIG. 3 is a block diagram illustrating a configuration in the periphery of the carriage in FIG. 2. In FIG. 3, an ink channel is indicated by a solid line, and a flow direction of the ink is indicated by an arrow. FIG. 4 is a diagram illustrating an ink flow in the periphery of the carriage in FIG. 2.

Referring to FIG. 2 to FIG. 4, the carriage 16 includes a first sub tank 26, a plurality of second sub tanks 27, a deaerator 30, a plurality of inkjet heads 28, and a support body 29.

First, ink is supplied from an ink tank 25 to the first sub tank 26. The first sub tank 26 mainly has a function to heat the ink. In the first sub tank 26, the ink is moved while being heated. The deaerator 30 is connected to the first sub tank 26 by an ink channel. The ink is fed from the first sub tank 26 toward the deaerator 30.

In the ink fed to the deaerator 30, a gas may be dissolved and air bubbles may exist. The deaerator 30 has a function to remove such a dissolved gas and such air bubbles. The deaerator 30 has a hollow fiber filter 33 formed of a gas permeable film, and the dissolved gas and air bubbles are removed by being depressurized by a vacuum pump 76.

The ink deaerated by the deaerator 30 is fed to the four second sub tanks 27 on a downstream side. The second sub tanks 27 each have a main function to control pressure of the ink. In each of the second sub tanks 27, a back pressure is applied to the ink by a vacuum pump (not illustrated). Each inkjet head 28 communicates with each second sub tanks 27. The ink is fed from the second sub tanks 27 toward eight inkjet heads 28. The ink is jetted toward a sheet from the inkjet heads 28 in accordance with image data. The ink that not used in image forming is again supplied to the first sub tank 26.

The support body 29 supports the first sub tank 26, second sub tanks 27, the deaerator 30, and inkjet heads 28. In FIG. 2, the support body 29 is formed of a rectangular frame body, but the shape of the support body 29 is not particularly limited.

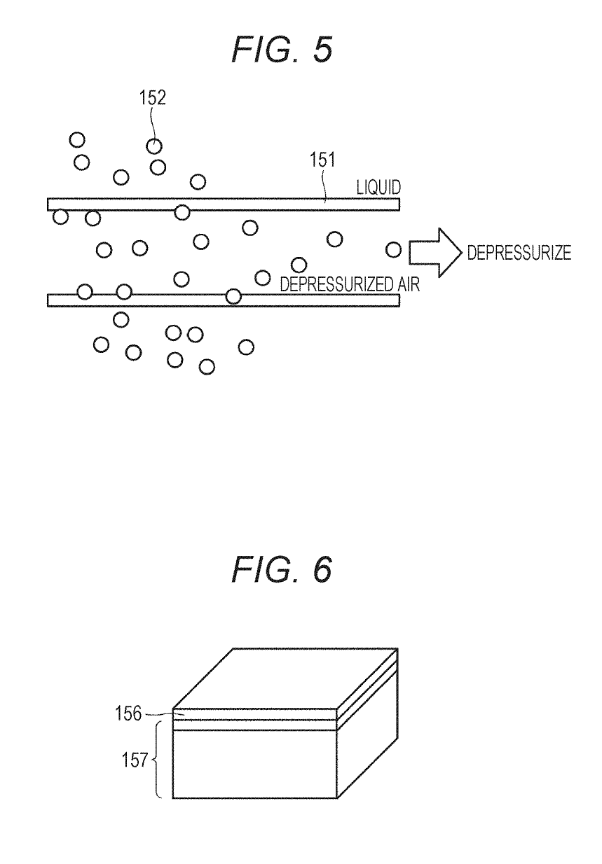

FIG. 5 is a view illustrating a principle of liquid deaeration. FIG. 6 is a cross-sectional view illustrating a gas permeable film. The principle of liquid deaeration by the deaerator will be described with reference to FIG. 5 and FIG. 6.

The deaerator includes a gas permeable film 151. Since the gas permeable film 151 is sandwiched between liquid and depressurized air, the air (air bubbles 152) contained in the liquid is removed. In other words, the liquid containing the air bubbles or dissolved gases contacts the gas permeable film 151, thereby moving only the air bubbles and dissolved gases to the depressurized air side. The gas permeable film 151 includes, for example: a surface layer 156 formed of a non-porous material; and a support layer 157 that supports the surface layer 156 and is formed of a porous material. The liquid having contacted the surface layer 156 cannot pass through the film due to a large molecular size thereof, but the gas having a small molecular size passes through the film. In the inkjet recording device, a silicone resin, a polyimide resin, a fluorine resin, or the like is suitable as a film material from the viewpoints of chemical resistance and heat resistance.

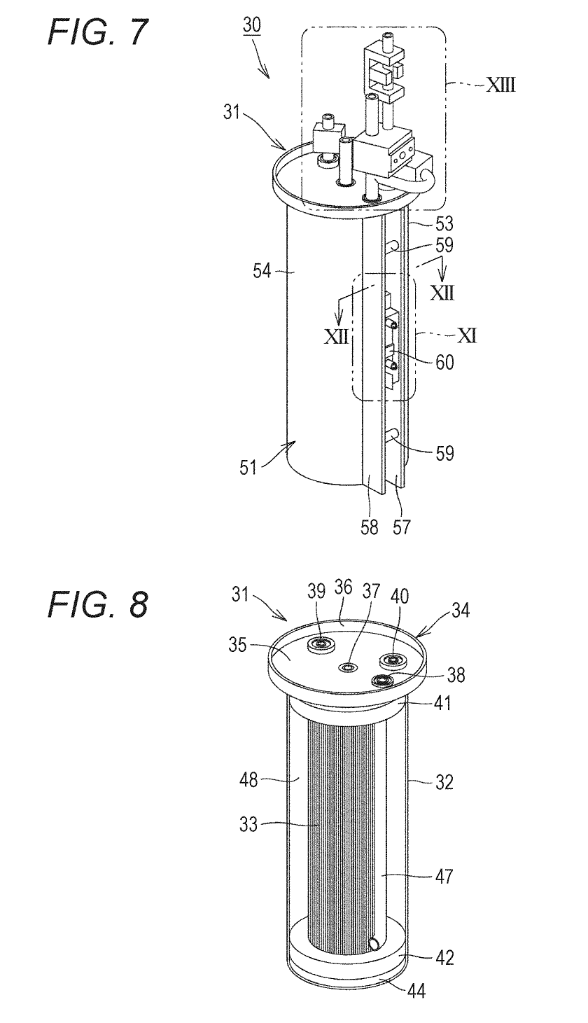

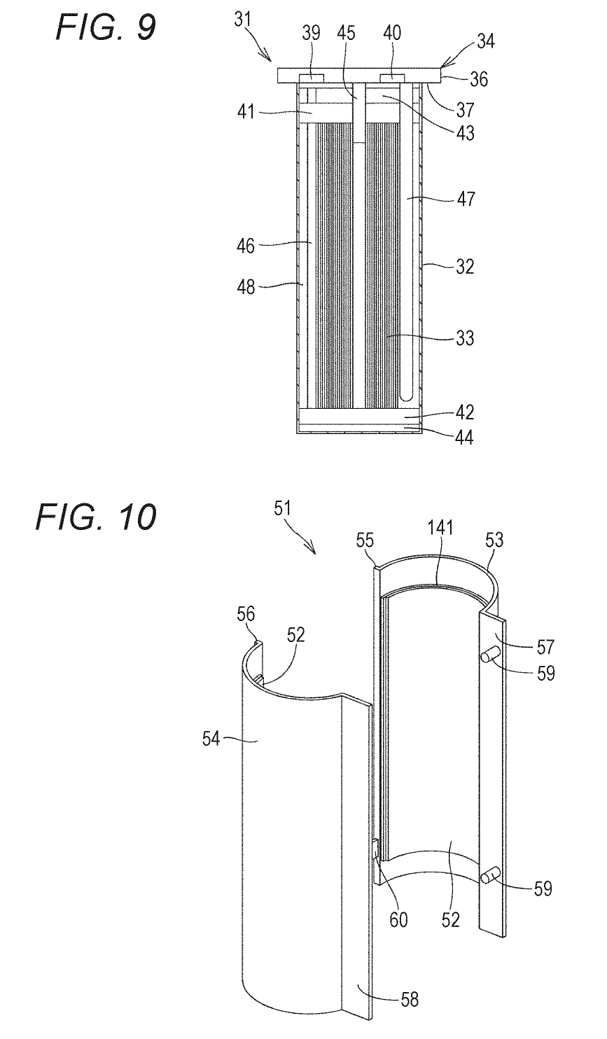

Subsequently, a structure of the deaerator 30 will be described in detail. FIG. 7 is a perspective view illustrating the deaerator. FIG. 8 is a perspective view illustrating a deaeration module in FIG. 7. FIG. 9 is a cross-sectional view illustrating the deaeration module in FIG. 7.

Referring to FIG. 7, the deaerator 30 includes a deaeration module 31 and a heating device 51. The deaeration module 31 removes a gas contained in ink provided as the liquid. The heating device 51 is provided integrally with the deaeration module 31. The heating device 51 heats the deaeration module 31.

Referring to FIG. 7 to FIG. 9, the deaeration module 31 is an external perfusion type deaeration module including, inside thereof, the hollow fiber filter 33 formed of a gas permeable film. The deaeration module 31 includes not only the hollow fiber filter 33 but also a housing 32, a lid body 34, a first potted portion 41, and a second potted portion 42.

The housing 32 has a cylindrical shape having one end provided with a bottom and the other end opened. The lid body 34 is provided to the housing 32 in a manner closing the opened end of the housing 32. The hollow fiber filter 33 is formed of the gas permeable film that allows only a gas to pass therethrough out of liquid and the gas. The hollow fiber filter 33 is housed in the housing 32.

The first potted portion 41 and the second potted portion 42 are each formed of a resin material. Each of the first potted portion 41 and the second potted portion 42 has a disk-like shape and is fitted into the housing 32. The first potted portion 41 and the second potted portion 42 are provided apart from each other in an axial direction of the housing 32. The first potted portion 41 is provided on the opened end side of the housing 32 and the second potted portion 42 is provided on the closed end side of the housing 32.

The hollow fiber filter 33 is arranged in a manner forming a cylindrical shape inside the housing 32. The hollow fiber filter 33 has one end in an axial direction supported by the second potted portion 42, and the hollow fiber filter 33 has the other end in the axial direction supported by the first potted portion 41.

Inside the housing 32, an ink chamber (liquid chamber) 48, a first air chamber (gas chamber) 43, and a second air chamber 44 are formed. The ink chamber 48 is formed between the first potted portion 41 and the second potted portion 42 in a partitioned manner. The first air chamber 43 is formed between the lid body 34 and the first potted portion 41 in the partitioned manner. The second air chamber 44 is formed between the second potted portion 42 and the bottom portion of the housing 32 in a partitioned manner.

The hollow fiber filter 33 is arranged in the ink chamber 48. The hollow fiber filter 33 has one end penetrating the second potted portion 42 and communicating with the second air chamber 44. The hollow fiber filter 33 has the other end penetrating the first potted portion 41 and communicating with the first air chamber 43.

An ink introduction port (liquid introduction port) 37, an ink discharge port (liquid discharge port) 38, an atmosphere release port 39, and an air vent (gas discharge port) 40 are provided in the lid body 34. The ink introduction port 37, ink discharge port 38, atmosphere release port 39, and air vent 40 are formed of through holes communicating between the outside and the inside of the housing 32.

The deaeration module 31 further includes an ink introduction pipe 45, an ink discharge pipe 47, and an atmosphere release pipe 46.

The ink introduction pipe 45 extends from the ink introduction port 37 toward the inside of the housing 32. The ink introduction pipe 45 penetrates the first potted portion 41 from the first air chamber 43 and communicates with the ink chamber 48 inside the housing 32. The ink introduction pipe 45 is opened in a space inside the hollow fiber filter 33 formed in the cylindrical shape in the ink chamber 48.

The ink discharge pipe 47 extends from the ink discharge port 38 toward the inside of the housing 32. The ink discharge pipe 47 penetrates the first potted portion 41 from the first air chamber 43 and communicates with the ink chamber 48 inside the housing 32. The ink discharge pipe 47 is opened in a space outside the hollow fiber filter 33 formed in the cylindrical shape in the ink chamber 48.

The atmosphere release pipe 46 extends from the atmosphere release port 39 toward the inside of the housing 32. Inside the housing 32, the atmosphere release pipe 46 penetrates the first potted portion 41 from the first air chamber 43, passes through the ink chamber 48, further passes through the second potted portion 42, and communicates with the second air chamber 44. The air vent 40 is opened to the first air chamber 43.

FIG. 10 is an exploded view of the heating device in FIG. 7. Referring to FIG. 2 to FIG. 3 and FIG. 7 to FIG. 10, the heating device 51 includes a first holding plate (first cover) 53, a second holding plate (second cover) 54, and a rubber heater 52, a heat insulating material 141, and a tension spring 59.

Each of the first holding plate 53 and the second holding plate 54 has a shape obtained by dividing a cylinder into two halves. The rubber heater 52 is bonded to an inner peripheral surface of each of the first holding plate 53 and the second holding plate 54 via the heat insulating material 141.

The first holding plate 53 has an engagement portion 55 and a bent portion 57 as components thereof. The second holding plate 54 has an engagement portion 56 and a bent portion 58 as components thereof. The engagement portion 55 is provided at one end in a circumferential direction of the first holding plate 53, and the engagement portion 56 is provided at one end in a circumferential direction of the second holding plate 54, respectively. The engagement portion 55 and the engagement portion 56 respectively have claw shapes engageable with each other. The bent portion 57 is formed by bending the other end in the circumferential direction of the first holding plate 53 radially outward, and the bent portion 58 is formed by respectively bending the other end in the circumferential direction of the second holding plate 54 radially outward, respectively. The tension spring 59 is provided in each of the bent portion 57 and the bent portion 58.

The first holding plate 53 and the second holding plate 54 are combined with each other so as to form a cylindrical shape. At this point, the engagement portion 55 and the engagement portion 56 are engaged with each other, and the bent portion 57 and the bent portion 58 are arranged in a manner facing each other. The tension springs 59 apply, to the first holding plate 53 and the second holding plate 54, elastic force in a direction in which the bent portion 57 and the bent portion 58 come close to each other.

The heating device 51 is supported by the support body 29. The heating device 51 may be provided in a manner detachable from the support body 29.

The deaeration module 31 and the heating device 51 are provided in a manner detachable from each other. In a state where the deaeration module 31 is attached to the heating device 51, the deaeration module 31 is held between the first holding plate 53 and the second holding plate 54 by the elastic force of the tension spring 59. At this point, the rubber heater 52 contacts an outer peripheral surface of the housing 32.

Meanwhile, in the present invention, “provided in a manner detachable from each other” means a case of being able to repeatedly obtain, with high reproducibility without making any special work, a state in which the other member is attached to one member and a state in which the other member is detached from one member.

In a case of detaching the deaeration module 31 from the heating device 51, the deaeration module 31 can be released from restraint by the first holding plate 53 and the second holding plate 54 by separating the bent portion 57 and the bent portion 58 from each other against the elastic force of the tension spring 59. The deaeration module 31 is removed from the heating device 51 by moving the deaeration module 31 in the axial direction thereof. In a case of attaching the deaeration module 31 to the heating device 51, a space between the first holding plate 53 and the second holding plate 54 is expanded by separating the bent portion 57 and the bent portion 58 from each other against the elastic force of the tension spring 59. In this state, the deaeration module 31 is inserted into the heating device 51. The deaeration module 31 is restrained by the first holding plate 53 and the second holding plate 54 by moving the bent portion 57 and the bent portion 58 close to each other.

The deaeration module 31 has a structure removably inserted into the heating device 51. The deaeration module 31 can be separated from the heating device 51.

With this structure, ink contained inside the deaeration module 31 can be heated because the deaeration module 31 is heated by the heating device 51. With this heating, even UV curable ink having viscosity increased by gelation can be prevented from liquid feeding failure from the deaerator 30. Additionally, since the hollow fiber filter 33 is gradually worn out, it is necessary to periodically replace the deaeration module 31. In this case, workability at the time of replacing the deaeration module 31 can be improved by separating the deaeration module 31 from the heating device 51. Additionally, compared to a case where the deaeration module 31 is replaced together with the heating device 51, a cost required for replacement can be reduced.

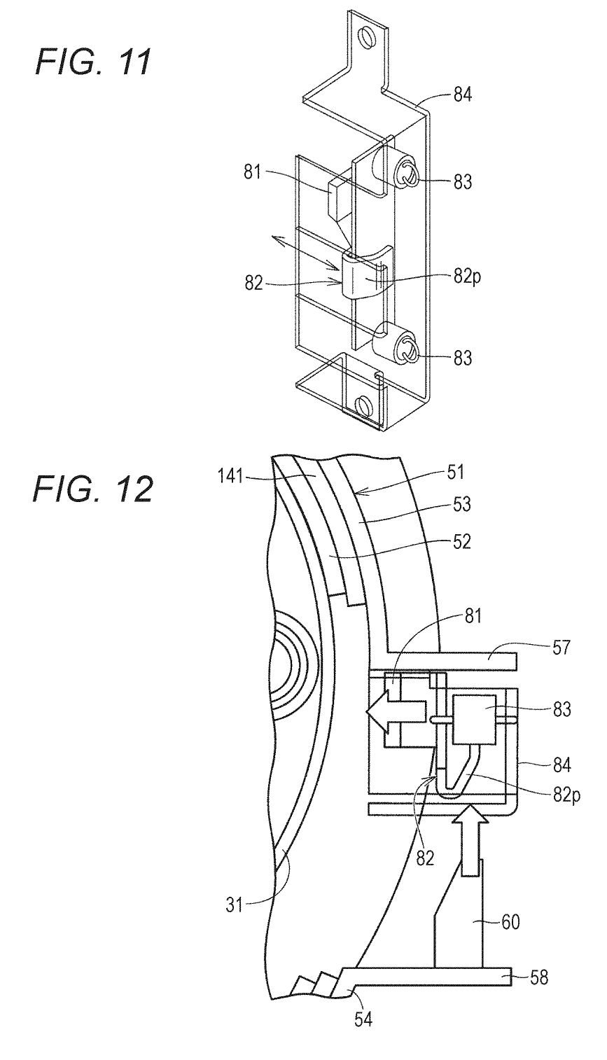

FIG. 11 is a perspective transparent view illustrating a range surrounded by a two-dot chain line XI in FIG. 7. FIG. 12 is a cross-sectional view illustrating the heating device viewed from a direction of an arrow on a line XII-XII in FIG. 7.

Referring to FIG. 7, FIG. 11 and FIG. 12, the deaerator 30 further includes a deaeration module temperature detector (first temperature detector) 81. The deaeration module temperature detector 81 detects a temperature of the deaeration module 31. The deaeration module temperature detector 81 detects a temperature of the housing 32. The deaeration module temperature detector 81 is formed of a thermistor.

The deaeration module temperature detector 81 is provided integrally with the deaeration module 31. The deaeration module temperature detector 81 is provided in a manner detachable from the deaeration module 31. The deaeration module temperature detector 81 can be separated from the deaeration module 31. The deaeration module temperature detector 81 is provided in the heating device 51.

When the deaeration module 31 is attached to the heating device 51, the deaeration module temperature detector 81 is positioned at a position capable of detecting the temperature of the deaeration module 31. When the deaeration module 31 is attached to the heating device 51, the deaeration module temperature detector 81 is positioned at a position contacting the housing 32.

The deaerator 30 further includes a sensor holding member 82, a sensor protective cover (protective member) 84, a tension spring 83, and a pin (moving system) 60.

The sensor protective cover 84 is attached to the bent portion 57 of the first holding plate 53. The sensor protective cover 84 is provided between the bent portion 57 and the bent portion 58. The sensor protective cover 84 is provided on an outer periphery of the deaeration module 31. The sensor protective cover 84 has a cover shape opened at a position facing the deaeration module 31.

The deaeration module temperature detector 81 is held by the sensor holding member 82. The sensor holding member 82 is arranged inside the sensor protective cover 84. The sensor holding member 82 is attached to the sensor protective cover 84 via the tension spring 83. The tension spring 83 applies, to the sensor holding member 82, elastic force in a direction in which the deaeration module temperature detector 81 is separated from the deaeration module 31 (elastic force toward a radially outer side of the deaeration module 31).

The sensor protective cover 84 is provided in a manner covering the deaeration module temperature detector 81 when the first holding plate 53 and the second holding plate 54 are separated from each other.

When the bent portion 57 and the bent portion 58 are separated from each other, the deaeration module temperature detector 81 is positioned by the elastic force of the tension spring 83 at a position away from the deaeration module 31 on the radially outer side. At this point, the deaeration module temperature detector 81 is covered with the sensor protective cover 84.

When the first holding plate 53 and the second holding plate 54 are combined with each other, the pin 60 moves the deaeration module temperature detector 81 from the position covered by the sensor protective cover 84 to a position capable of detecting the temperature of the deaeration module 31.

The pin 60 is provided at the bent portion 58. The pin 60 protrudes from the bent portion 58 in a direction approaching the bent portion 57. The sensor holding member 82 has an inclined portion 82p as a component thereof. The inclined portion 82p is inclined obliquely with respect to the facing direction of the bent portion 57 and the bent portion 58. When the bent portion 57 and the bent portion 58 come close to each other, the pin 60 contacts the inclined portion 82p. The sensor holding member 82 is moved radially inward of the deaeration module 31 against the elastic force of the tension spring 83. Along with movement of the sensor holding member 82, the deaeration module temperature detector 81 is moved to a position contacting the housing 32.

With this structure, since the deaeration module temperature detector 81 is separated from the deaeration module 31 at the time of replacing the deaeration module 31, workability at the time of replacing the deaeration module 31 can be further improved. Additionally, the cost required for replacement can be reduced because only the deaeration module 31 is replaced.

Furthermore, when the deaeration module 31 is attached to the heating device 51, the deaeration module temperature detector 81 is positioned at the position contacting the housing 32 of the deaeration module 31, and therefore, workability at the time of attaching the deaeration module 31 can be improved. Moreover, since the deaeration module temperature detector 81 is covered with the sensor protective cover 84 at the time of replacing the deaeration module 31, the deaeration module temperature detector 81 can be prevented from being damaged and ink can be prevented from adhering to the deaeration module temperature detector 81.

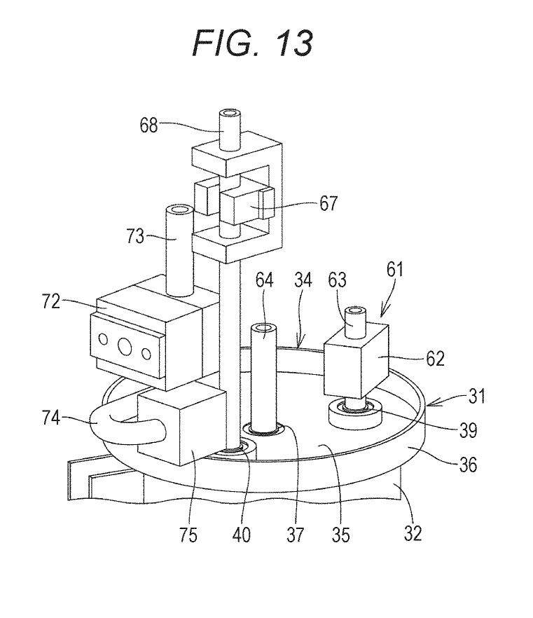

FIG. 13 is an enlarged perspective view illustrating a range surrounded by a two-dot chain line XIII in FIG. 7. Referring to FIG. 3, FIG. 7, and FIG. 13, the deaerator 30 further includes a contact liquid temperature detector (second temperature detector) 72, an ink leakage detector (liquid leakage detector) 67, an atmosphere release member 61. The contact liquid temperature detector 72, ink leakage detector 67, and atmosphere release member 61 are provided integrally with the deaeration module 31.

An ink introduction pipe 64 is connected to the ink introduction port 37 from the outside of the deaeration module 31. The ink introduction pipe 64 constitutes an ink channel directed to the deaeration module 31 from the first sub tank 26.

An ink discharge pipe 73 is connected to the ink discharge port 38 from the outside of the deaeration module 31. The ink discharge pipe 73 constitutes an ink channel directed to the second sub tank 27 from the deaeration module 31.

The contact liquid temperature detector 72 contacts the ink, thereby detecting a temperature of the ink. The contact liquid temperature detector 72 is provided in a manner detachable from the deaeration module 31. The contact liquid temperature detector 72 can be separated from the deaeration module 31.

The contact liquid temperature detector 72 is provided in a manner contacting ink discharged from the ink discharge port 38. The contact liquid temperature detector 72 is provided on a route of the ink discharge pipe 73. The contact liquid temperature detector 72 is formed of: an aluminum block formed with an ink channel inserted on the route of the ink discharge pipe 73; and a thermistor arranged on the ink channel.

With this structure, since the contact liquid temperature detector 72 is provided in a manner contacting the ink discharged from the ink discharge port 38, an ink temperature closer to a temperature of the ink contained in the deaeration module 31 can be detected. Particularly, in the case of an inkjet recording device, image quality on a sheet is largely changed by ink viscosity, and therefore, accurate detection of the ink temperature by the contact liquid temperature detector 72 and heat control are important. In the present embodiment, a proper ink temperature can be detected on a downstream side of the deaeration module 31 in which the ink is directed toward the inkjet head 28. Additionally, an ink deaeration level of the deaeration module 31 can be determined using the detected ink temperature.

A depressurizing pipe 68 is connected to the air vent 40 from the outside of the deaeration module 31. A vacuum pump 76 is connected to the depressurizing pipe 68. The air is sucked from the first air chamber 43 by activating the vacuum pump 76. At this point, since the hollow fiber filter 33 communicates with the first air chamber 43 and the second air chamber 44, the inside of the hollow fiber filter 33 and the second air chamber 44 are brought into a depressurized state together with the first air chamber 43.

The ink leakage detector 67 detects a state in which the ink mistakenly has passed through the hollow fiber filter 33 formed of the gas permeable film. The ink leakage detector 67 is provided in a manner detachable from the deaeration module 31. The ink leakage detector 67 can be separated from the deaeration module 31.

The depressurizing pipe 68 is formed of a transparent member. The ink leakage detector 67 is formed of a photosensor, and has a light emitting portion and a light receiving portion interposing the depressurizing pipe 68. When the hollow fiber filter 33 is damaged, the ink having entered the inside of the hollow fiber filter 33 from the ink chamber 48 adheres to the inside of the depressurizing pipe 68. Leakage of the ink can be detected from phenomena in which the depressurizing pipe 68 becomes opaque due to adhesion of the ink and a light receiving state in the ink leakage detector 67 is changed.

The atmosphere release member 61 opens the inside of the deaeration module 31 to the atmosphere. The atmosphere release member 61 is provided in a manner detachable from the deaeration module 31. The atmosphere release member 61 can be separated from the deaeration module 31.

The atmosphere release member 61 includes an atmosphere release pipe 63 and an atmosphere release valve 62. The atmosphere release pipe 63 is connected to the atmosphere release port 39 from the outside of the deaeration module 31. The atmosphere release valve 62 is provided on a route of the atmosphere release pipe 63. When the atmosphere release valve 62 is opened, the air enters the second air chamber 44 through the atmosphere release pipe 63 and the atmosphere release pipe 46. The air further passes through the inside of the hollow fiber filter 33 and is directed to the first air chamber 43, thereby eliminating clogging of the hollow fiber filter 33. Opening operation of the atmosphere release valve 62 is automatically executed at a frequency of about every two hours, for example.

As described above, the contact liquid temperature detector 72, ink leakage detector 67 and atmosphere release member 61 are provided in a manner detachable from the deaeration module 31. With this structure, workability at the time of replacing the deaeration module 31 can be further improved. Additionally, the cost required for replacement can be reduced because only the deaeration module 31 is replaced.

Meanwhile, in the present embodiment, described is the structure in which the ink introduction pipe 64, ink discharge pipe 73, atmosphere release pipe 63, and depressurizing pipe 68 are connected to the deaeration module 31 from the outside, but it may be possible to have a structure in which a block formed with various kinds of ink channels and air channels is connected to the deaeration module 31 instead of these pipe members.

The deaerator 30 further includes an ink circulator (liquid circulator) 77. The ink circulator 77 is provided integrally with the deaeration module 31. The ink circulator 77 is provided in a manner detachable from the deaeration module 31. The ink circulator 77 can be separated from the deaeration module 31.

The ink circulator 77 includes a pipe 78 and a liquid feed pump 79. The pipe 78 constitutes a circulation path including the deaeration module 31. The pipe 78 is branched from a middle of the ink channel extending from the deaeration module 31 (ink discharge port 38) toward the second sub tank 27, and is joined to a middle of the ink channel extending from the first sub tank 26 toward the deaeration module 31 (ink introduction port 37). The liquid feed pump 79 is provided on a route of the pipe 78.

The liquid feed pump 79 is activated in a case where no ink flows in the first sub tank 26 and the second sub tank 27 arranged on the upstream and downstream sides of the deaeration module 31, such as at the time of starting the inkjet recording device 100. Consequently, the ink can be circulated on the circulation path including the deaeration module 31, and ink deaeration can be executed.

With this structure, workability at the time of replacing the deaeration module 31 can be further improved because the ink circulator 77 is provided in a manner detachable from the deaeration module 31. Additionally, the cost required for replacement can be reduced because only the deaeration module 31 is replaced.

In the inkjet recording device 100 according to the present embodiment, the ink supplied from the ink tank 25 is collectively deaerated by the deaeration module 31 and fed to the plurality of inkjet heads 28 on the downstream side. Accordingly, a size of the deaerator 30 tends to be increased. On the other hand, workability at the time of replacing the deaeration module 31 is improved by adopting the structure in which only the deaeration module 31 can be replaced.

Additionally, in the deaeration module 31, the hollow fiber filter 33 arranged in a cylindrical shape is housed in the cylindrical housing 32. With this structure, the hollow fiber filter 33 can be housed in the housing 32 of a smaller size, and the deaeration module 31 can be reduced in size and weight. As a result, workability at the time of replacing the deaeration module 31 can be further improved.

Referring to FIG. 7, FIG. 8 and FIG. 13, the ink introduction port 37, ink discharge port 38, atmosphere release port 39, and air vent 40 are opened in one direction. The ink introduction port 37, ink discharge port 38, atmosphere release port 39, and air vent 40 are opened in a vertically upward direction (direction opposite to a gravity direction).

The lid body 34 includes a top 35 and a wall 36 as components thereof. The top 35 has a circular flat plate shape. The opened end of the housing 32 is closed by the top 35. The top 35 is provided with the ink introduction port 37, ink discharge port 38, atmosphere release port 39, and air vent 40. The wall 36 upstands from the top 35 and is provided in a manner surrounding the ink introduction port 37, ink discharge port 38, atmosphere release port 39, and air vent 40. With this structure, the lid body 34 forms a saucer-like shape.

The atmosphere release port 39 and the air vent 40 are each opened at a position higher than the ink introduction port 37 and the ink discharge port 38.

With this structure, since the ink introduction port 37, ink discharge port 38, atmosphere release port 39, and air vent 40 are opened in one direction, connecting directions of various kinds of pipe members to these ports can be set the same. With this structure, it is possible to improve workability at the time of connecting the various kinds of pipe members to the ink introduction port 37, ink discharge port 38, atmosphere release port 39 and air vent 40, respectively.

Furthermore, since the ink introduction port 37 and the ink discharge port 38 are opened in the vertically upward direction, the ink contained in the deaeration module 31 hardly spills through the ink introduction port 37 and the ink discharge port 38. Even in a case where the ink contained in the deaeration module 31 flows out, the ink can be stopped on the lid body 34 because the lid body 34 has the saucer-like shape. At this point, since the atmosphere release port 39 and the air vent 40 are opened at the position higher than the ink introduction port 37 and the ink discharge port 38, the ink can be prevented from entering the first air chamber 43 and the second air chamber 44 via the atmosphere release port 39 and the air vent 40.

The ink introduction port 37, ink discharge port 38, atmosphere release port 39, and air vent 40 are asymmetrically arranged when the opened faces thereof are viewed from the front side. The ink introduction port 37 is arranged at a center of the lid body 34. Two ports arbitrarily selected from among the ink discharge port 38, atmosphere release port 39, and air vent 40 are provided at positions neither line symmetric nor point symmetric with respect to the center of the lid body 34.

With this structure, a worker can easily recognize correspondence relations between the ink introduction port 37, ink discharge port 38, atmosphere release port 39, air vent 40 and various kinds of pipe members, and therefore, workability at the time of replacing the deaeration module 31 can be further improved.

### Second Embodiment

In the present embodiment, a control flow applied to the deaerator 30 described in a first embodiment will be described.

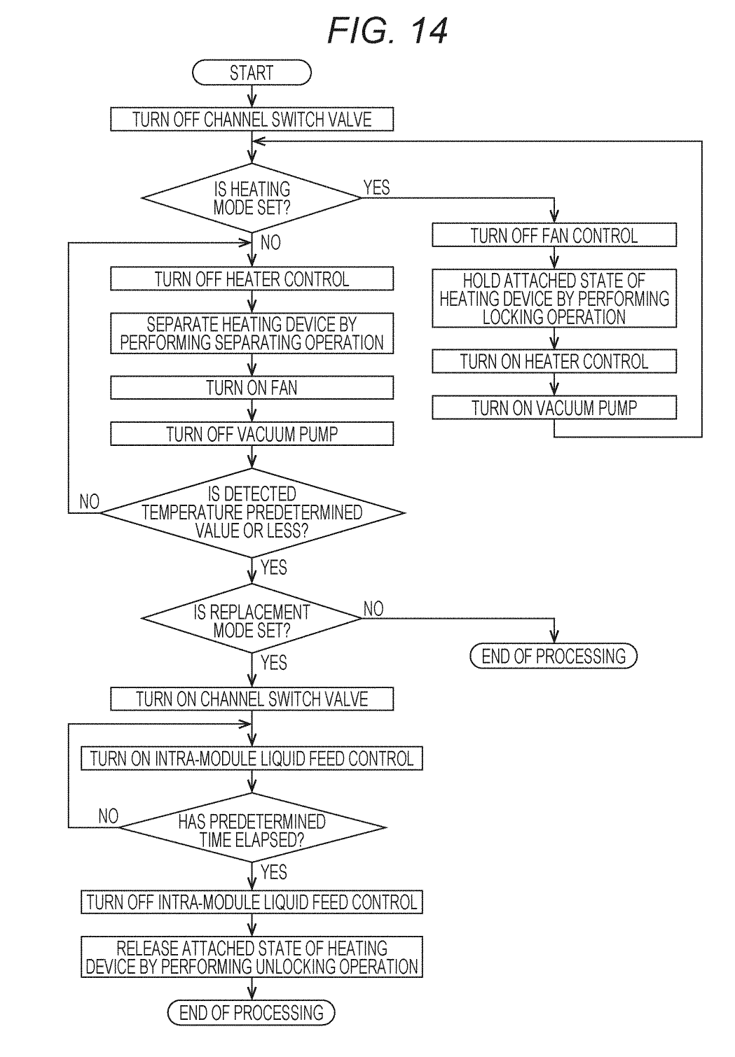

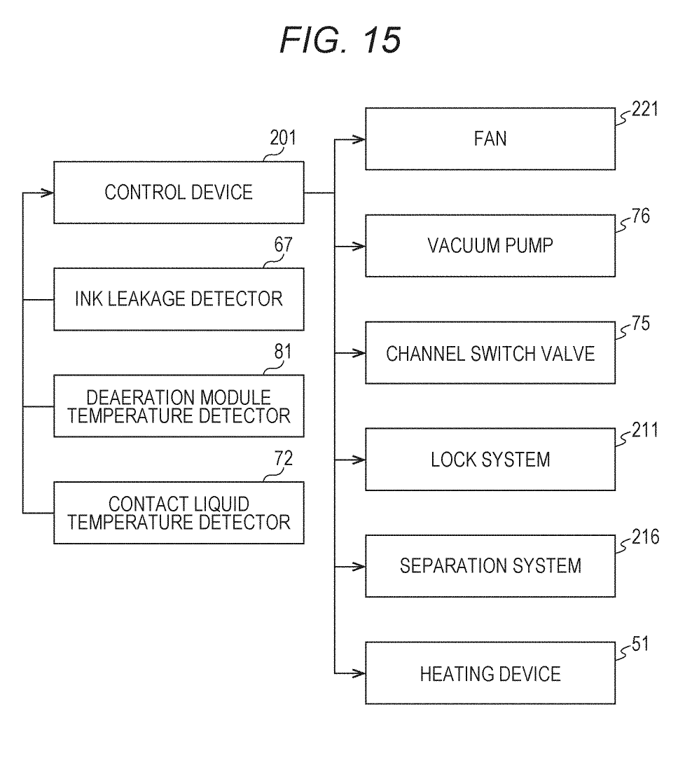

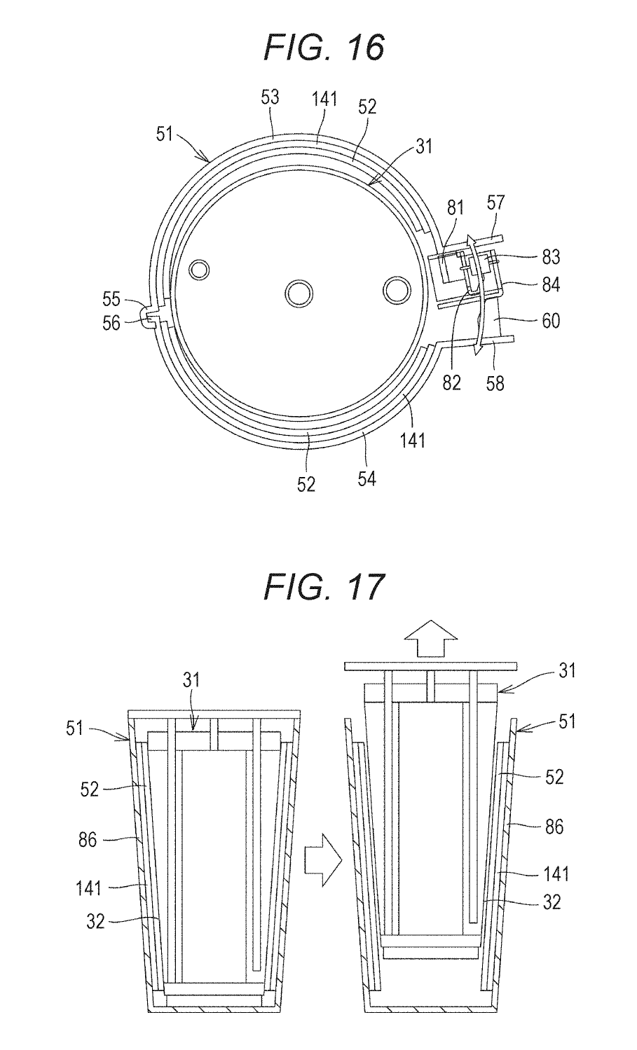

FIG. 14 is a flowchart illustrating the control flow of the deaerator. FIG. 15 is a block diagram of a configuration related to the control flow in FIG. 14. FIG. 16 is a cross-sectional view illustrating a state in which a heating device is separated from a deaeration module by separating operation of a separation system. FIG. 17 is a cross-sectional view illustrating a modified example in a state in which the heating device in FIG. 16 is separated from the deaeration module.

Referring to FIG. 3, FIG. 14 and FIG. 15, an inkjet recording device 100 further includes a control device 201. The deaerator 30 further includes a fan 221, a channel switch valve 75, a lock system 211, and a separation system 216.

The control device 201 controls an activation state in each of the fan 221 and a vacuum pump 76, open/close operation of the channel switch valve 75, locking operation/unlocking operation of the lock system 211, and separating operation of the separation system 216.

The fan 221 is mounted on each carriage 16 in FIG. 2. The fan 221 is provided such that air can be blown to a deaeration module 31 during activation of the fan. The channel switch valve 75 is provided on a route connecting an air channel extending from the deaeration module 31 (air vent 40) toward the vacuum pump 76 and an ink channel extending from the deaeration module 31 (ink discharge port 38) toward a second sub tank 27.

The lock system 211 holds an attached state of the deaeration module 31 to the heating device 51 by performing locking operation, and releases holding of the attached state of the deaeration module 31 to the heating device 51 by performing unlocking operation. The lock system 211 is formed of, for example, a pin member to be inserted into or removed from the deaeration module 31.

The separation system 216 separates the heating device 51 from the deaeration module 31 by performing separating operation. The separation system 216 is formed of, for example, a cam member to be interposed and inserted between a bent portion 57 and a bent portion 58 in FIG. 7. As illustrated in FIG. 16, the bent portion 57 and the bent portion 58 are moved away from each other by rotating the cam member, and the deaeration module 31 is released from restraint by a first holding plate 53 and a second holding plate 54.

As illustrated in FIG. 17, a housing 32 of the deaeration module 31 is formed in a tapered cylindrical shape in which a diameter is gradually increased as a position approaches an opening end of the housing 32, and the deaeration module 31 may be moved upward by forming, instead of the first holding plate 53 and the second holding plate 54, a cover 86 of the heating device 51 in a tapered cylindrical shape corresponding to the shape of the housing 32.

The channel switch valve 75 is normally in a closed state and blocks a place between an air channel extending from the deaeration module 31 (air vent 40) toward the vacuum pump 76 and an ink channel extending from the deaeration module 31 (ink discharge port 38) toward the second sub tank 27.

The control device 201 determines whether the heating device 51 is in a heating mode to heat the deaeration module 31 or in a non-heating mode not to heat the deaeration module 31. The heating mode is a mode to prepare for operation start of the inkjet recording device 100, and the non-heating mode is a mode to prepare for machine down of the inkjet recording device 100 or replacement of the deaeration module 31.

In a case where the heating device 51 is in the heating mode, the control device 201 stops activation of the fan 221, causes the lock system 211 to perform locking operation, turns on heater control in the heating device 51, and activates the vacuum pump 76. Consequently, the deaeration module 31 is heated, and also ink deaeration is executed by the deaeration module 31. At this point, since a state in which the deaeration module 31 is attached to the heating device 51 is held by the locking operation of the lock system 211, a user can be prevented from touching the deaeration module 31 having a high temperature.

In a case where the heating device 51 is in the non-heating mode, the control device 201 turns off the heater control in the heating device 51, causes the separation system 216 to perform separating operation in the state where the lock system 211 is kept performing the locking operation, and activates the fan 221, and stops activation of the vacuum pump 76. At this point, since the heating device 51 is separated from the deaeration module 31 by the separating operation of the separation system 216, cooling of the deaeration module 31 can be accelerated.

The control device 201 determines whether a temperature of the deaeration module 31 detected by a deaeration module temperature detector 81 or an ink temperature detected by a contact liquid temperature detector 72 is a predetermined value or less.

In a case where the detected temperature is the predetermined value or less, the control device 201 determines whether a mode is in a replacement mode of the deaeration module 31. For example, in a case where a printing time exceeds a predetermined period, or in a case where ink leakage is detected by an ink leakage detector 67, it is determined that the mode is in the replacement mode for the deaeration module 31. In a case where the mode is not in the replacement mode, normal machine down is executed, and the processing ends.

In a case of determining that the mode is in the replacement mode, the air channel extending from the deaeration module 31 (air vent 40) toward the vacuum pump 76 is made to communicate with the ink channel extending from the deaeration module 31 (ink discharge port 38) toward the second sub tank 27 by opening the channel switch valve 75. Subsequently, the ink feeding to a first air chamber 43 from an ink chamber 48 is started by turning on intra-module liquid feed control. After a predetermined time has elapsed after starting the ink feeding, the intra-module liquid feed control is turned off

Holding the attached state of the deaeration module 31 to the heating device 51 is released by causing the lock system 211 to perform unlocking operation. Consequently, the deaeration module 31 can be detached from the heating device 51.

Since the ink contained in the deaeration module 31 is fed to the first air chamber 43 at the time of replacing the deaeration module 31, peripheral contamination caused by overflow of the ink from the ink chamber 48 can be prevented. Additionally, since the ink that has not been deaerated is not fed to a downstream side of the deaeration module 31, ink quality on the downstream side of the deaeration module 31 can be maintained. Furthermore, since unlocking operation by the lock system 211 is executed after the lapse of the predetermined time from start of ink feeding, the ink can be more surely prevented from overflowing from the ink chamber 48.

Note that the ink contained in the deaeration module 31 may also be fed to the downstream side of the deaeration module 31 by the intra-module liquid feed control. In this case, for example, a liquid feed pump and a valve may be provided on the ink channel extending from the deaeration module 31 (ink discharge port 38) toward the second sub tank 27, and the valve may be closed after discharging the ink from the deaeration module 31 by the liquid feed pump.

### Third Embodiment

In the present embodiment, various modified examples in each of an inkjet recording device 100 and a deaerator 30 described in a first embodiment will be described.

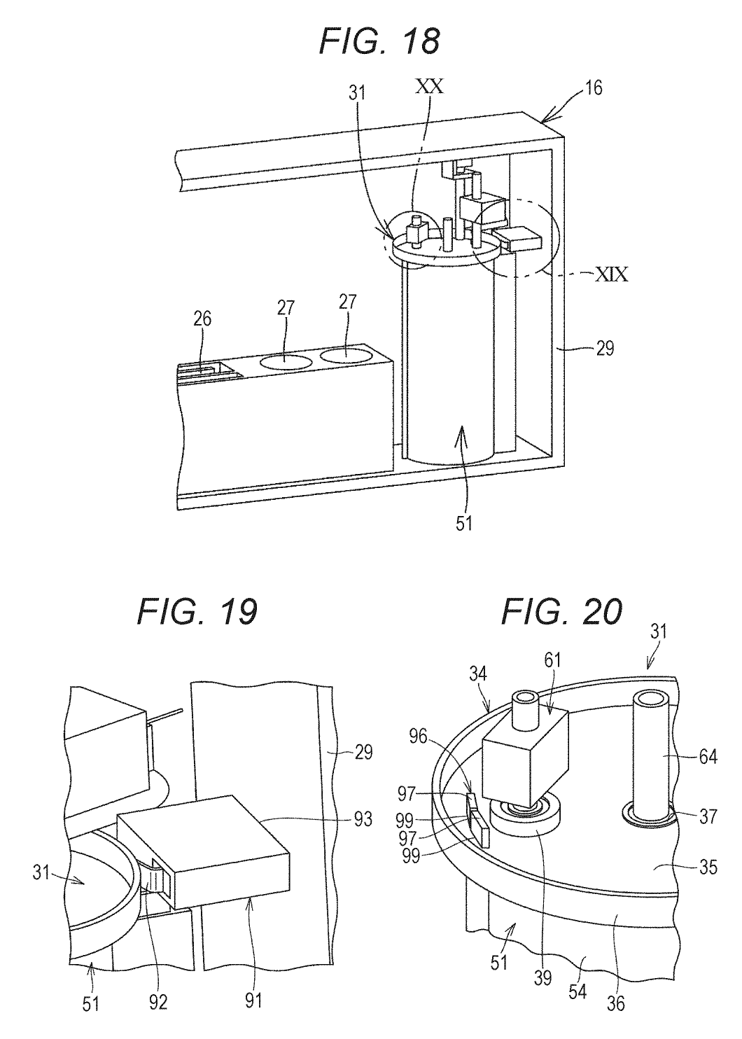

FIG. 18 is a perspective view illustrating a first modified example of a carriage in FIG. 2. FIG. 19 is an enlarged perspective view illustrating a range surrounded by a two-dot chain line XIX in FIG. 18. FIG. 20 is an enlarged perspective view illustrating a range surrounded by a two-dot chain line XX in FIG. 18.

Referring to FIG. 18 and FIG. 19, the inkjet recording device 100 further includes a deaeration module detector 91 in the present modified example. The deaeration module detector 91 is provided in the carriage 16. The deaeration module detector 91 has a sensor 92 and a cover 93. The sensor 92 detects an attached state of a deaeration module 31 to a heating device 51. The cover 93 is provided in a manner covering the sensor 92.

The deaeration module detector 91 is installed at a support body 29 adjacent to the deaerator 30. The deaeration module detector 91 is formed of a micro switch. The sensor 92 includes: an actuator unit that transmits external force and external movement to an internal system; and a contact point system that is opened/closed by receiving force transmission from the actuator unit. The cover 93 is provided in a manner covering a part of the actuator unit and an entire part of the contact point system.

When the deaeration module 31 is attached to the heating device 51, a lid body 34 contacts the actuator unit of the sensor 92. Consequently, the sensor 92 is turned on, and a state in which the deaeration module 31 is attached to the heating device 51 is detected. At this point, since the sensor 92 is covered with the cover 93, the sensor 92 can be prevented from being damaged and ink can be prevented from adhering to the sensor 92.

Referring to FIG. 18 and FIG. 20, four carriages 16 are provided in a manner corresponding to four colors of cyan (C), magenta (M), yellow (Y), and black (K) in the inkjet recording device 100. The inkjet recording device 100 further includes an incompatibility prevention system 96 whereby only a deaeration module 31 corresponding to a specific carriage 16 can be attached to the specific carriage 16.

The incompatibility prevention system 96 is formed of a fitting system including a plurality of protrusions 97 and a plurality of fitting holes 99. The plurality of protrusions 97 is provided in the heating device 51. The plurality of protrusions 97 protrudes from a second holding plate 54 in an axial direction thereof. The plurality of fitting holes 99 is provided in the deaeration module 31. The plurality of fitting holes 99 is provided corresponding to the number, intervals, and sizes of the plurality of protrusions 97. The plurality of fitting holes 99 is provided in the lid body 34. When the deaeration module 31 is attached to the heating device 51, the plurality of protrusions 97 is fitted into the plurality of fitting holes 99, respectively.

The number, intervals, and sizes of the plurality of protrusions 97 and those of the plurality of fitting holes 99 are different among the four color carriages 16. With this structure, a deaeration module 31 corresponding to magenta (M) cannot be attached to a carriage 16 corresponding to cyan (C).

Meanwhile, in a case where the heating device 51 is provided in a manner detachable from each carriage 16, for example, an incompatibility prevention system whereby only a deaerator 30 corresponding to a specific carriage 16 can be attached to the specific carriage 16 may be provided in each of the heating device 51 and the support body 29.

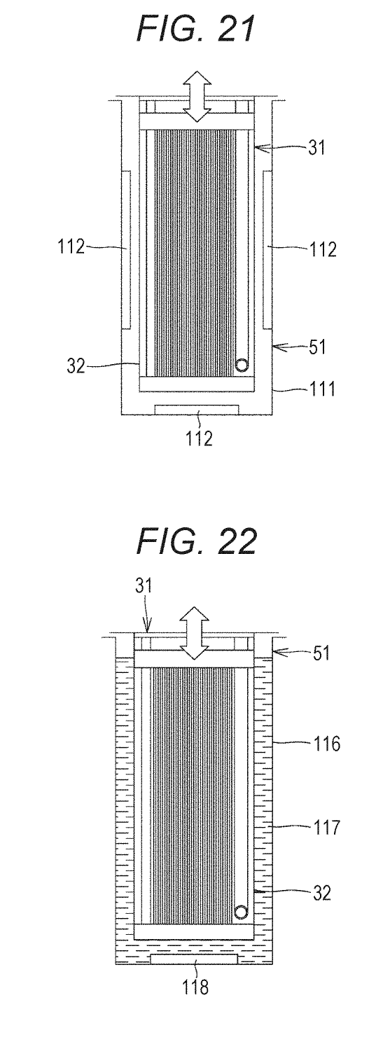

FIG. 21 is a cross-sectional view illustrating a first modified example of the deaerator in FIG. 3. FIG. 22 is a cross-sectional view illustrating a second modified example of the deaerator in FIG. 3.

Referring to FIG. 21, a housing 32 is made of a magnetic material in the present modified example. The housing 32 is made of, for example, iron or nickel. The heating device 51 includes a case 111 and an IH coil (coil) 112.

The case 111 has a cylindrical shape opened in one direction and having a bottom. The deaeration module 31 is removably inserted into the case 111 via the opened end. In a state where the deaeration module 31 is housed in the case 111, the IH coil 112 is provided in a manner facing the housing 32. The IH coil 112 is provided in a manner facing an outer peripheral surface of the housing 32 and a bottom portion of the housing 32.

When the IH coil 112 is energized in this structure, the housing 32 is heated by electromagnetic induction action. In this case, heating efficiency can be more improved compared to a rubber heater 52 in the first embodiment because the housing 32 directly generates heat. Additionally, attachment/detachment of the deaeration module 31 to/from the heating device 51 can be easily performed because the coil 112 is separated from the housing 32.

Referring to FIG. 22, in the present modified example, the heating device 51 includes a case 116, a heating medium 117, and heater 118 (heating source).

The case 116 has a cylindrical shape opened in one direction and having a bottom. The deaeration module 31 is removably inserted into the case 116 via the opened end. The heating medium is, for example, water. The heating medium 117 is arranged in the case 116. In a state where the deaeration module 31 is housed in the case 116, a gap between the case 116 and the deaeration module 31 is filled with the heating medium 117. The heater 118 heats the heating medium 117, the heater 118 is immersed in the heating medium 117. The heater 118 is provided in a manner facing the bottom portion of the deaeration module 31.

With this structure, attachment/detachment of the deaeration module 31 to/from the heating device 51 can be easily executed similar to the above-described modified example. Additionally, since a temperature of the heating medium 117 become uniform by convection of the heating medium 117, the number of installation places of heaters 118 can be reduced. With this structure, the heater 118 can be easily protected, and the heater 118 can be effectively prevented from being damaged at the time of replacing the deaeration module 31.

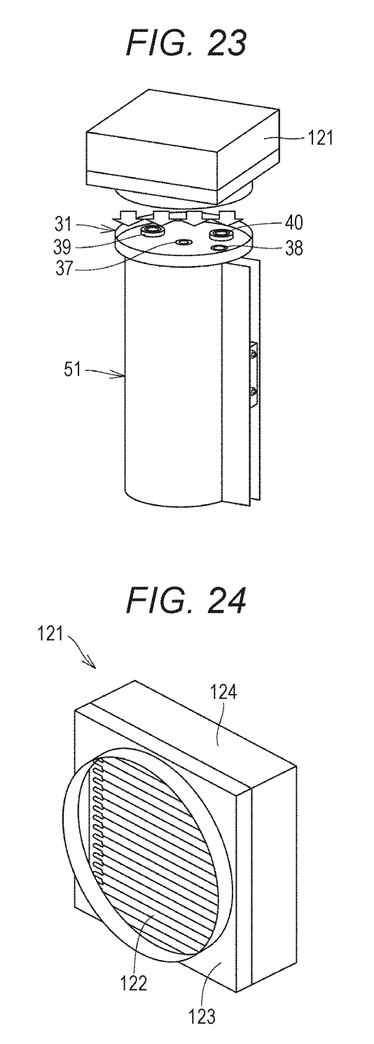

FIG. 23 is a perspective view illustrating a second modified example of the carriage in FIG. 2. FIG. 24 is a perspective view illustrating a UV irradiation device in FIG. 23.

Referring to FIG. 23 and FIG. 24, ink is UV curable ink in the present modified example. The inkjet recording device 100 further includes a UV irradiation device 121. The UV irradiation device 121 is detachably connected to the deaeration module 31. The UV irradiation device 121 emits UV to an ink introduction port 37 and an ink discharge port 38.

The UV irradiation device 121 includes a UV lamp 122, a power source 124, and an adapter portion 123. The UV lamp 122 receives power supply from the power source 124 and emits the UV. The UV lamp 122 is not particularly limited as far as the UV is emitted, and an LED or a cold-cathode tube can be used, for example.

The adapter portion 123 is formed in a manner detachable from the deaeration module 31. The adapter portion 123 has a cylindrical portion that can be fitted to the lid body 34 (wall 36). The UV irradiation device 121 is detachably installed at any position of the inkjet recording device 100, such as at a carriage 16.

The UV irradiation device 121 is connected to the deaeration module 31 by fitting the adapter portion 123 to the lid body 34 at the time of replacing the deaeration module 31. The ink is cured by emitting the UV to the ink introduction port 37 and the ink discharge port 38 by using the UV lamp 122. At this point, since the UV irradiation device 121 is connected to the deaeration module 31, the UV is prevented from leaking to the outside.

With this structure, since the ink is cured by irradiation with the UV, the deaeration module 31 can be replaced without worrying about ink spillage.

Meanwhile, it may also be possible to adopt a replacement method for the deaeration module 31 in which a worker brings the UV irradiation device 121 at the time of replacing the deaeration module 31 and connects the same to the deaeration module 31.

The present invention is applied to, for example, a deaerator that deaerates ink and an inkjet recording device provided with such a deaerator.

Although embodiments of the present invention have been described and illustrated in detail, the disclosed embodiments are made for purposes of illustration and example only and not limitation. The scope of the present invention should be interpreted by terms of the appended claims, and intended to include meanings equivalent to the scope of claims as well as all of changes falling within the scope of the claims.

What is claimed is:

1. A deaerator comprising:
a deaeration module that removes a gas contained in liquid; and
a heating device that is provided integrally with the deaeration module and heats the deaeration module, wherein
the deaeration module and the heating device are provided in a manner detachable from each other.

2. The deaerator according to claim 1, further comprising a first temperature detector that is provided integrally with the deaeration module and detects a temperature of the deaeration module, wherein
the first temperature detector is provided in a manner detachable from the deaeration module.

3. The deaerator according to claim 2, wherein
the first temperature detector is provided in the heating device, and
when the deaeration module is attached to the heating device, the first temperature detector is positioned at a position capable of detecting the temperature of the deaeration module.

4. The deaerator according to claim 3, wherein
the heating device includes a first cover and a second cover, wherein when the first and second covers are combined with each other, the deaeration module is held between the covers, and when the first and second covers are separated from each other, the deaeration module is released, and
the deaerator further comprises:
a protective member provided in a manner covering the first temperature detector when the first cover and the second cover are separated from each other; and
a moving system that moves the first temperature detector from a position covered by the protective member to the position capable of detecting the temperature of the deaeration module when the first cover and the second cover are combined with each other.

5. The deaerator according to claim 1, further comprising a second temperature detector that is provided integrally with the deaeration module and detects a temperature of liquid by contacting the liquid, wherein
the second temperature detector is provided in a manner detachable from the deaeration module.

6. The deaerator according to claim 5, wherein
the deaeration module has a liquid discharge port that discharges the liquid, and
the second temperature detector is provided in a manner contacting the liquid discharged from the liquid discharge port.

7. The deaerator according to claim 1, wherein
the deaeration module has a gas permeable film that allows only a gas to pass through the gas permeable film out of the liquid and the gas,
the deaerator further comprises a liquid leakage detector that is provided integrally with the deaeration module and detects a state in which the liquid mistakenly has passed through the gas permeable film, and
the liquid leakage detector is provided in a manner detachable from the deaeration module.

8. The deaerator according to claim 1, wherein
the deaeration module includes a gas permeable film that allows only a gas to pass through the gas permeable film out of the liquid and the gas,
the deaerator further comprises an atmosphere release member that is provided in a manner detachable from the deaeration module and opens the inside of the deaeration module to atmosphere, and
the atmosphere release member is provided in a manner detachable from the deaeration module.

9. The deaerator according to claim 1, wherein
the deaeration module includes: a liquid introduction port that introduces the liquid; and a liquid discharge port that discharges the liquid,
the deaerator further comprises a liquid circulator that includes: a pipe constituting a circulation path including the deaeration module; and a liquid feed pump provided on a route of the pipe, the liquid circulator being provided integrally with the deaeration module, and
the liquid circulator is provided in a manner detachable from the deaeration module.

10. The deaerator according to claim 1, wherein the deaeration module includes: a gas permeable film that has a cylindrical shape and allows only a gas to pass through the gas permeable film out of the liquid and the gas; and a housing that has a cylindrical shape and houses the gas permeable film.

11. The deaerator according to claim 1, wherein
the heating device has a heating mode to heat the deaeration module, and a non-heating mode not to heat the deaeration module, and
the deaerator further comprises a lock system that holds an attached state of the deaeration module to the heating device by performing locking operation during the heating mode.

12. The deaerator according to claim 11, further comprising a separation system that separates the deaeration module from the heating device during the non-heating mode that is also a replacement mode to prepare for replacement of the deaeration module.

13. The deaerator according to claim 11, further comprising:
a first temperature detector that detects a temperature of the deaeration module; and
a second temperature detector that detects a temperature of liquid by contacting the liquid, wherein
the lock system releases holding of the attached state of the deaeration module to the heating device by performing unlocking operation when the temperature of the deaeration module detected by the first temperature detector or the liquid temperature detected by the second temperature detector becomes a predetermined temperature or less.

14. The deaerator according to claim 1, wherein
the heating device has a heating mode to heat the deaeration module, and a non-heating mode not to heat the deaeration module, and
the deaerator further comprises a fan that blows air toward the deaeration module in order to prepare for replacement of the deaeration module during the non-heating mode.

15. The deaerator according to claim 1, wherein the liquid is discharged from the deaeration module during the replacement mode which prepares for replacement of the deaeration module.

16. The deaerator according to claim 1, wherein
the deaeration module includes: a liquid chamber to/from which liquid is introduced and discharged; a gas permeable film that is arranged in the liquid chamber and allows only a gas to pass through the gas permeable film out of the liquid and the gas; and a gas chamber to which the gas having passed through the gas permeable film is introduced, and
the liquid is fed from the liquid chamber to the gas chamber during the replacement mode which prepares for replacement of the deaeration module.

17. The deaerator according to claim 15, further comprising a lock system that holds the attached state of the deaeration module to the heating device, wherein
the lock system releases holding of the attached state of the deaeration module to the heating device by performing unlocking operation after a lapse of a predetermined time from start of liquid discharging or liquid feeding in the deaeration module.

18. The deaerator according to claim 1, wherein
the deaeration module includes: a liquid introduction port that is connected to a first pipe and introduces the liquid; a liquid discharge port connected to a second pipe and discharges the liquid; and a gas discharge port that is connected to a third pipe and discharges the gas, and
the liquid introduction port, the liquid discharge port, and the gas discharge port are opened in one direction.

19. The deaerator according to claim 18, wherein the liquid introduction port, the liquid discharge port, and the gas discharge port are arranged asymmetrically when viewed from the one direction.

20. The deaerator according to claim 18, wherein the liquid introduction port and the liquid discharge port are opened in a vertically upward direction.

21. The deaerator according to claim 20, wherein the deaeration module includes: a top where the liquid introduction port and the liquid discharge port are opened, and a wall that upstands from the top and is provided in a manner surrounding the liquid introduction port and the liquid discharge port.

22. The deaerator according to claim 18, wherein the gas discharge port is opened at a position higher than the liquid introduction port and the liquid discharge port.

23. The deaerator according to claim 1, wherein
the deaeration module includes a housing that contains liquid and formed of a magnetic material, and
the heating device includes a coil provided in a manner facing the housing.

24. The deaerator according to claim 1, wherein the heating device includes: a heating medium arranged around the deaeration module; and a heating source that heats the heating medium.

25. An inkjet recording device comprising a deaerator according to claim 1, wherein
a residual gas in ink is removed by the deaeration module.

26. The inkjet recording device according to claim 25, further comprising an ink tank that stores ink, wherein
the deaeration module collectively deaerates the ink supplied from the ink tank, and
the inkjet recording device further comprises a plurality of inkjet heads each of which jets the ink from the deaerator.

27. The inkjet recording device according to claim 25, further comprising:
a carriage on which the deaerator is provided; and
a deaeration module detector that is provided in the carriage and includes: a sensor that detects an attached state of the deaeration module to a heating device; and a cover that covers the sensor.

28. The inkjet recording device according to claim 25, further comprising:
a plurality of deaerators that deaerates ink of colors different from each other;
a plurality of carriages respectively provided with the plurality of the deaerators; and
an incompatibility prevention system that allows only a deaeration module corresponding to a specific carriage to be attached to the specific carriage.

29. The inkjet recording device according to claim 25, wherein
the ink is a UV curable ink,
the deaeration module includes: an ink introduction port that introduces the ink; and an ink discharge port that discharges the ink, and
the inkjet recording device further comprises a UV irradiation device that is detachably connected to the deaeration module and irradiates the ink introduction port and the ink discharge port with UV.
